(19) United States
(12) Patent Application Publication
(10) Pub. No.: US 2005/0089333 A1
(43) Pub. Date: Apr. 28, 2005

(54) Combining high-speed data and analog video on an optical fiber

(76) Inventor: Near Margalit, Westlake Village, CA (US)

Correspondence Address: GARY L. SHAFFER, 901 BANKS PLACE, ALEXANDRIA, VA, 22312, US

(21) Appl. No.: 10/956,363

(22) Filed: Oct. 4, 2004

Related U.S. Application Data
(60) Provisional application No. 60/507,963, filed on Oct. 3, 2003.

(51) Int. Cl. H04B 10/00

(52) U.S. Cl. 398/139

(57) ABSTRACT

The invention provides means and methods for combining high-speed data and analog video signals over the same optical fiber. Optical diplexers and tri-plexers are employed to combine bi-directional data transmission and uni-directional video transmission over a single optical fiber. In one aspect, optical diplexers and tri-plexers of the invention include an optical data transmitter, an optical data receiver and an optical video receiver when they are disposed to function at the receiving end of a video signal. In another aspect, optical diplexers and tri-plexers of the invention include an optical data transmitter, an optical data receiver and an optical video transmitter when they are disposed to function at the transmission end of a video signal. The invention enables the simultaneous transmission of one signal to multiple video signal receivers. Numerous combinations of different optical wavelength pairs can be used to separate data and video signals.

### RELATED APPLICATIONS

The present application claims priority to U.S. Provisional Application No. 60/507,963, filed Oct. 3, 2003. The cited Application is hereby incorporated by reference in its entirety.

### FIELD OF THE INVENTION

This invention relates to communication over optical fibers, and more specifically with combining data and video signals to be communicated by means of optical fibers.

### BACKGROUND OF THE INVENTION

In many applications requiring very wide-band video signals, it is impractical to digitize such video signals, and it is desirable to transmit such signal over the communication medium as analog video signals. Typically the transmission medium is an optical fiber used in high-speed data network communications. Analog video signals become a problem when such signals need to be transmitted over high-speed data networks. Separation between the data and the video is possible by way of wavelength separation. However, data is handled by equipment completely different from that used for video, and therefore video signals must be inserted into the optical fiber separately from the digital data transmitter, and extracted from the optical fiber separately from the digital data receiver.

To save cost in installations, optical fibers are often utilized in bi-directional transmission over a single fiber, wherein optical signals are simultaneously transmitted over the same fiber in both directions. In typical prior art applications shown in FIGS. 1, and 2, signals of the same wavelength are simultaneously transmitted in both directions over the fiber.

A typical prior art installation where digital data and video signals are transmitted over an optical fiber is shown in FIG. 1. As video signals can not be processed in the data transceivers, the video signals are inserted into the optical fiber after the data transceiver, and extracted from the optical fiber before the data transceiver on the other side of the optical cable.

Another typical prior art installation is presented in FIG. 2, wherein a single video source is broadcast to multiple video receivers, utilizing multiple optical fiber data network links. This installation requires numerous optical couplers, and video optical receivers in addition to the normal data transceivers used for bi-directional data transmission.

### DESCRIPTION OF THE INVENTION

To allow bi-directional data transmission over a single optical fiber, optical di-plexers are presently used in optical transceivers, as shown in FIG. 6. In the diplexer, an angled unidirectional mirror allows the light generated by the laser transmitter to pass through, and continue in a straight line towards the optical fiber. Light arriving through the fiber from the opposite side of the optical fiber does not pass through the mirror, and is deflected in an angle towards the optical receiver's photodiode.

Bi-directional data transmission can be done using a single wavelength for transmission in both directions. However, very often data is transmitted in one direction using one optical wavelength, and a different wavelength is used for data transmission in the opposite direction.

An optical tri-plexer is an extension of the optical di-plexer, whereas it allows the combination of two optical transmitters and a single optical receiver, or one optical transmitter and two optical receivers, in a single optical transceiver unit. In a tri-plexers as in di-plexers the optical transmitters and the optical receivers need not be mounted inside the di-plexer or tri-plexer. Light signals can enter and exit the di-plexer or tri-plexer via optical fibers as shown in FIG. 7.

In the present invention, optical tri-plexers are employed to combine bi-directional data transmission and uni-directional video transmission over a single optical fiber. In the present invention two types of optical tri-plexers are used. On the receiving end of the video signal, an optical tri-plexer is used comprising of an optical data transmitter, an optical data receiver, and an optical video receiver. As described above, the transmitter and the receiver may or may not be mounted in the tri-plexer, and may be connected via separate optical fibers. On the transmission end of the video signal, an optical tri-plexer comprises of an optical data transmitter, an optical data receiver, and an optical video transmitter.

To allow a single video source to broadcast to a plurality of video receivers, the optical tri-plexer on the transmission end of the video signal is assembled such that the optical video transmission signal is connected via an optical fiber, as shown in FIG. 8. The optical video transmission fibers of all the video transmission tri-plexers are connected together to a multi-way optical power splitter, which is also connected to the video transmitter. Video optical signals generated by the video optical transmitter are split between all the video transmission tri-plexers, and are then transmitted via all the optical data links to all the video optical receivers.

To separate between the data and the video signal transmitted over the optical fibers, different optical wavelengths are used. For example purposes the video signals are transmitted over an optical carrier with an optical wavelength of 1550 nanometer. Data is transmitted over a wavelength of 1490 nanometers in one direction, and 1310 nanometers in the opposite direction. Numerous permutations of such wavelengths, and wavelength pairs, are suitable for use with the invention. The presently specified wavelengths are exemplary only, and different wavelengths, and numerous other combinations of wavelength assignments are possible.

### BRIEF DESCRIPTION OF THE DRAWINGS

FIG. 1 shows a prior art optical fiber with video and data transmitted on the same fiber.

FIG. 2 shows a prior art installation of multiple fiber-optic data links carrying video generated by a single video source, and delivered to multiple receivers.

FIG. 3 shows an optical tri-plexer adapted and arranged according to the invention for combining video signals with bi-directional data transmission.

FIG. 4 shows an optical tri-plexer adapted and arranged according to the invention for combining video signal reception with bi-directional data transmission.

FIG. 5 shows an installation of multiple optical fiber links combining video signals from one source, with bi-directional data transmission and multiple video receivers.

FIG. 6 shows an embodiment of an optical di-plexer of the invention which combines an optical transmitter and an optical receiver in the same enclosure.

FIG. 7 shows an optical di-plexer of the invention which combines an optical transmitter in one enclosure and an optical receiver in a different enclosure by connecting them with optical fibers.

FIG. 8 shows an optical tri-plexer with optical fiber connections adapted for carrying high-speed signals.

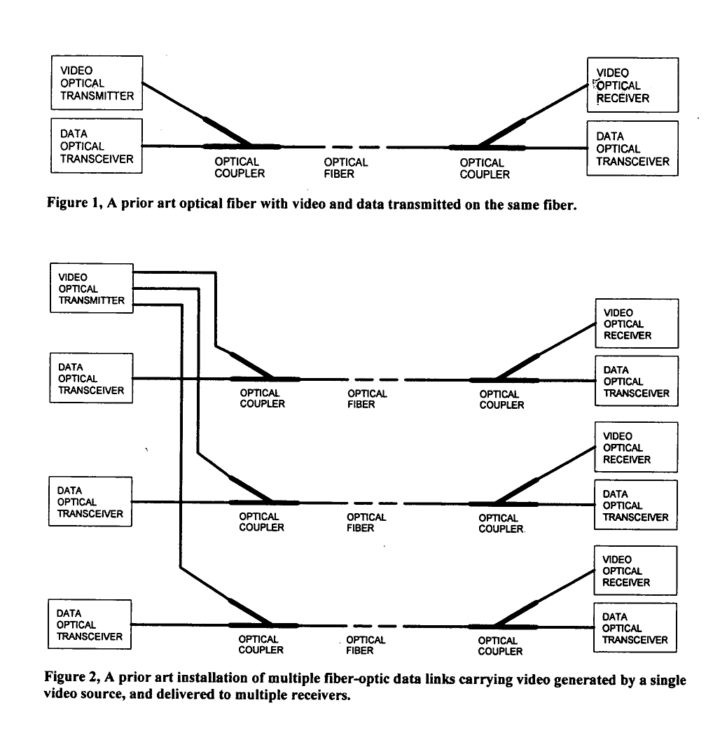

### DETAILED DESCRIPTION OF THE INVENTION

In one important aspect, the invention utilizes optical tri-plexers as a means to combine both optical video signals and bi-directional optical data signals on a single fiber for transmission, and also provides the separation of the respective signals at reception locations to thereby yield separate reception of video signals and data signals.

In the present description, reference is made to the accompanying drawings, which form a part hereof, and in which are shown by way of illustration of specific embodiments in which the invention may be practiced. These embodiments are described in sufficient detail, to enable those of ordinary skill in the art, to make and use the invention. It is to be understood that structural, logical or procedural changes may be made to the specific embodiments disclosed without departing from the spirit and scope of the present invention.

In one important aspect, the invention utilizes optical diplexers and tri-plexers as a means to combine both optical video signals and bi-directional optical data signals on a single fiber for transmission, and also provides the separation of the respective signals at receiver locations to thereby yield the separate and simultaneous reception of video signals and data signals.

FIG. 2 shows a prior art video installation in which conventional optical fiber installations are utilized to distribute video signals. As shown in FIG. 2, such a conventional installation requires many optical power combiners and splitters which require expensive upkeep and result in significant optical power loss. The methods and devices of the invention described herein employ a novel approach to distribution of video signals, and are advantageously adaptable for use with established fiber-optic installations. Moreover, the present methods and devices provide the transmission and reception of high-speed data simultaneously over the same fiber back and forth in both directions.

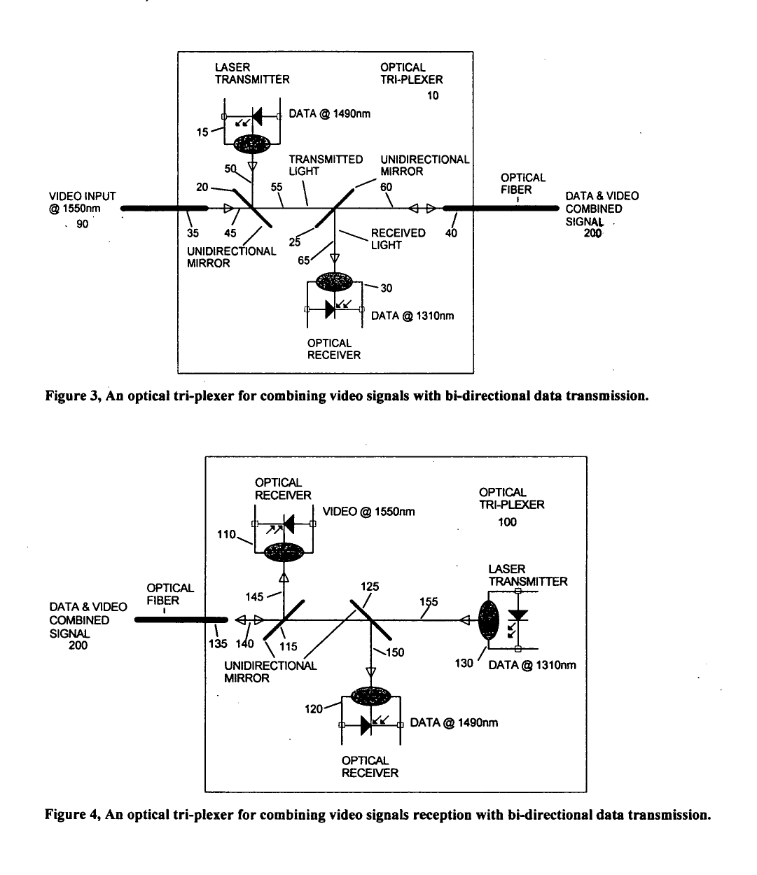

FIG. 3 shows one embodiment of an optical tri-plexer of the invention adapted and arranged for the transmission of video signals along with bi-directional data communication over a single optical fiber. In optical tri-plexer 10, two angled, unidirectional mirrors 20, and 25, are used. These mirrors are transparent to light arriving in one direction and reflective to light arriving in the opposite direction. The relative transparency of the mirrors also depends on the wavelength of the light signals which are directed toward them. The mirrors are transparent to certain wavelengths, and are reflective to others. In the tri-plexer 10, the presence of two mirrors allows the optical video signal 90, typically at a wavelength of 1550 nanometers, to enter via optical fiber 35, and to pass straight through the mirrors toward optical fiber 40. Data optical signals 50, typically at a wavelength of 1490 nanometers, are generated by laser transmitter 15, and are deflected by mirror 20 toward input/output fiber 40. Part of signal 90 also passes through mirror 25, and continues in a straight line toward the optical fiber. Light signals 65, typically at a wavelength of 1310 nanometers, arriving through fiber 40 from the opposite end of the optical fiber do not pass through mirror 25, and are deflected at an angle toward optical receiver 30.

Thus, FIG. 3 shows an optical tri-plexer used to allow bi-directional high-speed data transmission and to combine a unidirectional video-carrying optical signal. In triplexer 10, laser transmitter 15 is used to transmit high-speed data signals, while optical receiver 30 is used to receive high-speed data optical signals. Both transmitter 15 and receiver 30 are installed such that their respective functional axes are perpendicular to the axis of optical fibers 35 and 40, which in turn are both on a single, or common, axis. Video input signal 90 @@@ is applied via optical fiber 35. Mirrors 20 and 25 are transparent to optical video signal 45, such that signal 45 passes straight through them to fiber 40. The optical signal 50 carrying the high-speed data is deflected by the mirror 20 towards the fiber 40 passing through the mirror 25 as this mirror is transparent to light coming from either the fiber 35 or the transmitter 15. Optical signals 60 carrying high-speed data arriving via the fiber 40 is deflected by the mirror 25 towards the optical receiver 30.

Using the tri-plexer 10, as shown in FIG. 3, video signals 90 arriving via fiber 35 are combined in fiber 40 with the data transmission signals 50, and the received data signals 65.

FIG. 4 presents another embodiment of the invention utilizing an optical tri-plexer somewhat different from the one shown in FIG. 3. In the tri-plexer according to the invention and shown in FIG. 4, light signal 200 comprised of video and data signals, enters via fiber 135. Mirror 115 is transparent to the wavelength 1490 nanometers, and reflective to the wavelength 1550 nanometers. As a result, the video signal at a wavelength of 1550 nanometers is reflected towards the video optical receiver 110. In contrast, the data signal at a wavelength of 1490 nanometers passes through mirror 115. Second mirror 125 is reflective to the data signals at a wavelength of 1490 nanometers, and these signals are therefore reflected towards the optical receiver 120. Signals generated by the optical transmitter 130, at a wavelength of 1310 nanometers arrive at the mirrors from the opposite direction and can therefore pass through straight to the optical fiber 135. The optical tri-plexers of FIGS. 3 and 4 can be combined to form a data transmission or communications module.

FIG. 4, shows an optical fiber terminal 100 capable of receiving high-speed data combined with video signals 200 via the optical fiber 135. The unidirectional mirror 115 acts as a mirror for signals with a wavelength of 1550 nm, but is transparent to optical signals of wavelength 1490 nm. Thus optical signals at 1550 nm carrying the video are deflected by the mirror 115 towards the optical receiver 110 which converts the optical signals to electrical video signals. Meanwhile optical signals carrying the high-speed data are not deflected by the mirror 115, but instead are directed by the mirror 125 toward the high-speed data optical receiver 120. Optical signals of 1310 nm carrying high-speed data generated by the optical transmitter 130 are not deflected by either mirror and are coupled directly into the optical fiber 135.

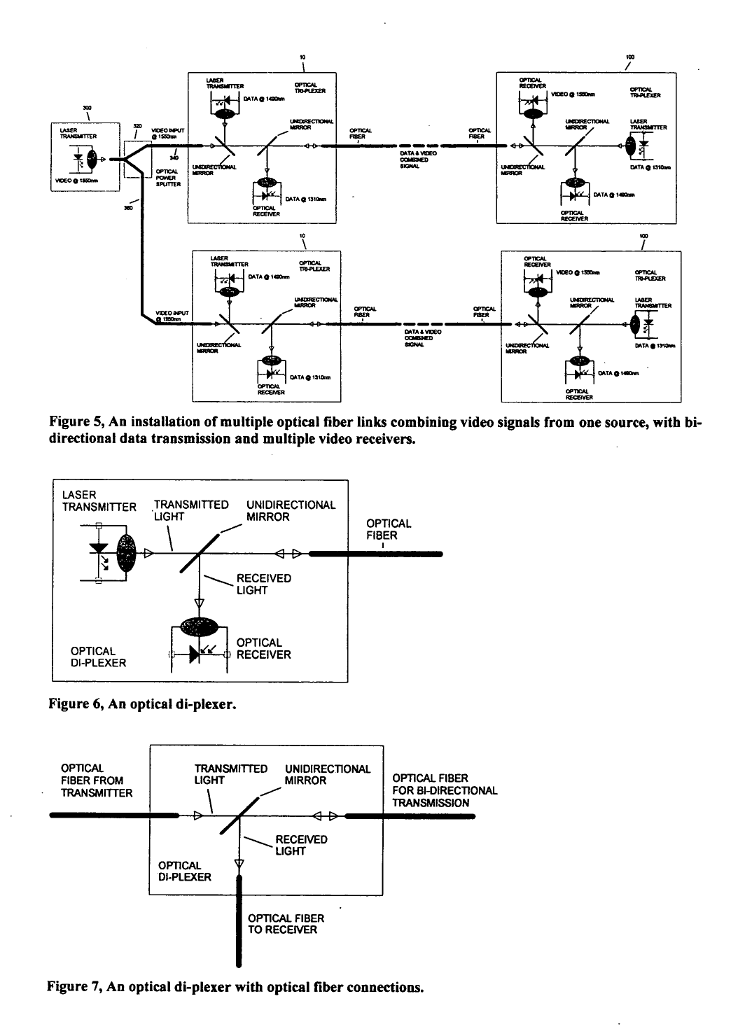

FIG. 5 depicts a video distribution system based on the present invention. Here two bi-directional high-speed data fiber-optic links are utilized also as conduits for optical signals carrying video signals generated by the video transmitter 300. Signals generated by the transmitter 300 are coupled to the optical power splitter 320. Out of the splitter 320 said optical signals are applied via the optical fibers 340 and 360 to the optical links each comprised of a tri-plexer 10, an optical fiber, and an optical terminal 100.

To better understand how optical signals are transmitted over single fiber in two directions refer to FIG. 6. FIG. 6 shows an optical di-plexer. It combines an optical transmitter and an optical receiver in a single enclosure, arranged such that the axis of the receiver and the axis of the transmitter are perpendicular to each other. A unidirectional mirror is placed at an angle of 45 degree at the intersection point of the transmitter axis and the receiver axis. Due to the directivity, or selective transparency of the mirror, optical signals generated by the laser transmitter inside the enclosure pass through the mirror as if it is transparent, and coupled into the optical fiber. On the other hand, optical signals received via the optical fiber are deflected by the mirror and thus are directed to the optical receiver in the enclosure.

FIG. 7 shows an optical diplexer similar in function to the one shown in FIG. 6, except the optical transmitter are not located inside one enclosure, but instead the optical transmitter and the optical receiver are each located in tis own enclosure, coupled to the diplexer via optical fibers.

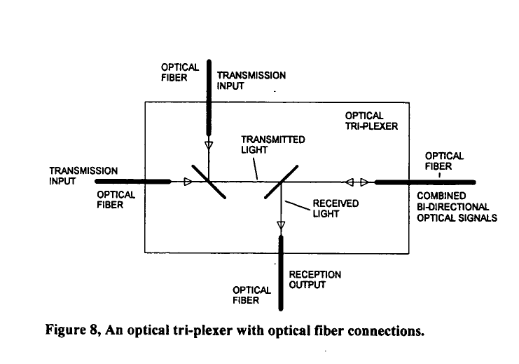

FIG. 8, shows an optical tri-plexer similar in function to the one shown in FIG. 3 whereas in FIG. 8 the high-speed carrying optical signals are coupled via optical fibers.

1. A fiber-optic transceiver for transmitting both video and data signals, and for receiving data signals, comprising:
at least one laser transmitter, the transmitter being adapted for transmitting data;
at least one optical receiver;
at least one first unidirectional mirror,
at least one output optical fiber;
at least one video signal input source;
wherein the at least one first unidirectional mirror is disposed in the path of transmission of the laser transmitter and also in the path of the video fiber input source such that essentially all of the signal transmitted by the laser transmitter is deflected by the first mirror into the output optical fiber and essentially all of the video signal is passed through both of the mirrors into the output optical fiber.

2. The fiber-optic transceiver of claim 1, wherein the laser transmitter transmits frequencies in a first range of from 1,300 to 1,600 nanometers.

3. The fiber-optic transceiver of claim 1, wherein the laser optical receiver receives frequencies in a second range of from 1,100 to 1,400 nanometers.

4. The fiber-optic transceiver of claim 3, wherein the frequencies of the first range are selected such that they are at least 200 nanometers different from the frequencies of the second range.

5. A fiber-optic tri-plexer for receiving both video and data signals and for transmitting data signals, comprising:
at least one laser transmitter, the transmitter being adapted for transmitting data;
a first optical receiver adapted for receiving frequencies in a first range;
a second optical receiver adapted for receiving frequencies in a second range;
at least one first unidirectional mirror;
at least one input optical fiber;
at least one output optical fiber; and
at least one video signal input source;
wherein the at least one first unidirectional mirror is disposed in the path of transmission of the laser transmitter and also in the path of the video fiber input source such that essentially all of the signal transmitted by the laser transmitter is passed through the first mirror into the output optical fiber and the input video signal of the first frequency range partially deflected by the first mirror into the first optical receiver and the remainder of the input video signal is passed through the first mirror to the second mirror where it is deflected into the second optical receiver.

6. The fiber-optic transceiver of claim 6, wherein the frequencies of the first range are between 1,300 and 1,600 nanometers.

7. The fiber-optic transceiver of claim 6, wherein the frequencies of the first range are between 1,100 and 1,400 nanometers.

8. The fiber-optic transceiver of claim 6, wherein the frequencies of the first range are selected such that they are at least 200 nanometers different from the frequencies of the second range.
